(19) United States
(12) Patent Application Publication
(10) Pub. No.: US 2008/0097824 A1
(43) Pub. Date: Apr. 24, 2008

(54) Campaign Performance Report

(76) Inventors: Patrick Julien, Mascouche (CA); Bryan Mongeau, Montreal (CA); Daniel Parisien, Montreal (CA)

Correspondence Address: TECHNOLOGY LAW GROUP, LLC, 2215 West State Street, BOISE, ID, 83702, US

(21) Appl. No.: 11/828,149

(22) Filed: Jul. 25, 2007

Related U.S. Application Data
(60) Provisional application No. 60/820,589, filed on Jul. 27, 2006.
(60) Provisional application No. 60/820,591, filed on Jul. 27, 2006.
(60) Provisional application No. 60/820,594, filed on Jul. 27, 2006.
(60) Provisional application No. 60/820,595, filed on Jul. 27, 2006.
(60) Provisional application No. 60/820,598, filed on Jul. 27, 2006.

(51) Int. Cl. G06Q 10/00; G06Q 30/00

(52) U.S. Cl. 705/10; 705/14

(57) ABSTRACT

A system and method for efficiently estimating and reporting the rendition of digital advertising messages in a network of electronic displays in which advertising message blocks, supporting loop undersaturation and loop oversaturation, are formed, wherein the resulting advertising message block is constrained to a preexisting length specified by a loop policy associated with each display frame in the system.

### CROSS-REFERENCE TO RELATED APPLICATIONS

This application claims priority under 35 U.S.C. §119(e) to U.S. Provisional Application No. 60/820,589, filed Jul. 27, 2006, entitled “Network Control Time Spans,” U.S. Provisional Application No. 60/820,591, filed Jul. 27, 2006, entitled “Broadcast Day,” U.S. Provisional Application No. 60/820,594, filed Jul. 27, 2006, entitled “Campaign Performance Report,” U.S. Provisional Application No. 60/820,595, filed Jul. 27, 2006, entitled “Day Part Frame Criteria,” and U.S. Provisional Application No. 60/820,598, filed Jul. 27, 2006, entitled “Fine-Grained Criteria Targeting,” the entire contents of each are hereby incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates to enhancements to a digital signage system. More particularly, the invention relates to a system and method of estimating and reporting the number of times advertising messages are displayed during an advertising campaign on a network of digital signs.

Consumer product advertising is rapidly migrating from traditional media, such as billboards, newspapers, magazines, mailings, television and radio, to a medium of networks of digital signs. A digital sign network typically includes a number of display units, where each display unit typically is divided into multiple frames, and each frame is able to display an advertising message. The digital paradigm is vastly superior to traditional signage systems because content can be changed instantly and inexpensively, allowing a single display unit to service multiple advertisers. This is often a “win-win” situation for both consumers and advertisers. Consumers generally find changing content more interesting. The digital paradigm benefits advertisers who can “time share” valuable advertising space and venues with other advertisers, giving them more affordable access to formally cost prohibitive advertising platforms.

In the digital signage arena, advertising customers typically purchase advertising space by purchasing a digital advertising campaign. In a typical digital advertising campaign, the customer provides the ad content for one or more campaign advertising messages and specifies generally the display types, locations, times, and frequency to display campaign advertising messages. At some point of the process, the digital signage system needs to be queried to determine what is available and then assignments to map the campaign advertising messages to particular frames at particular times are made so that the content is displayed in appropriate venues, at appropriate times, repeated in a manner consistent with the requirements of the purchased advertising campaign.

Pricing is generally a function of the number of times a message is displayed to the viewing public. In order to execute an advertising campaign, the available inventory of a digital advertising network needs to be inventoried to determine available times. In small systems, the advertising schedule for each signage display in the system can be examined and message assignments can be made on a display-by-display basis. This approach works well for very small systems having a relatively few number of displays and a relatively few number of advertisers. However, as soon as either the number of the displays in the network grows to anything beyond a few or the number of advertisers increases to more than a handful, the mapping of advertising campaign messages to available display units quickly becomes much more complex. If the mapping is not done carefully and efficiently, advertising space is wasted when displays have insufficient content at some particular time, and the opportunity to sell that space is forever lost when the time passes. In a busy system, inefficiency can easily lead to a loss of sales when it is not possible to accurately determine the unused inventory of available advertising space.

What is needed is a system and method of mapping advertising campaign to displays in a digital signage to avoid wasting advertising space that allows accurate predictions of prospective advertising campaigns and accurate reporting of completed advertising campaigns in a large digital signage network.

### BRIEF SUMMARY OF THE INVENTION

The present invention solves the problems addressed above and provides additional new and unobvious benefits over the prior art. In one embodiment, campaign advertising messages, herein defined to be a messages associated with one or more advertising campaigns, are assigned to display units as follows. First, the electronic display units are partitioned into one or more target display frames, each display frame capable of displaying an advertising message, independent from other display frames that may be on the same electronic display unit. Associated with each targeted display frame is a display schedule that identifies the days and times of days that it make sense for the display frame to display a message and generally reflects the operating hours of the venue hosting the display. Also associated with each targeted display frame is a loop policy that specifies a time period for repeating (or looping) display content. For example, a loop policy that indicates a time period of 20 minutes means that it is desirable to repeat content every twenty minutes. This is accomplished by concatenating multiple campaign advertising messages to form an advertising message block that corresponds to the time period specified by the loop policy. The present invention requires that the length of the advertising message block closely confirms to the requirements of loop policy, and thus the invention provides for the inclusion of loop filler content designed to ensure the length of the advertising message block closely approximates the time period specified in the loop policy.

In the present invention, by default, each campaign advertising message occurs once in an advertising message block and thus is repeated exactly once each loop cycle. However, by design, loop undersaturation, wherein a message is repeated less than once per cycle, such as once every three cycles is permitted. Also allowed is loop oversaturation where a particular message may be repeated more than once in a single loop cycle.

When the system is set up as described above, the invention provides for a fast and accurate repetition estimator to accurately predict in advance how many times a particular message will appear when the advertising campaign is deployed. Specifically, for messages subject to neither loop undersaturation nor loop oversaturation, the estimation can be accurately calculated by determining the total amount of time the target display frame is operational for the reporting period as dictated by the display schedule, and then dividing that time by the time period specified by the loop policy.

Adjustments are made to the calculation to compensate for loop undersaturation or loop oversaturation, when present. Specifically, both loop undersaturation and loop oversaturation change the average number of times a message is displayed per loop from one to some other number. Thus, to accurately estimate message counts for messages with an associated loop saturation parameter, the average number of times a message will be displayed per loop needs to be calculated and the resulting count needs to be multiplied by that average. For example, if the original formula determines a count of 100 without saturation, but a particular message is subjected to a loop oversaturation parameter of 2 (the message is displayed twice per loop), then the average number of displays per loop is two, and the resulting count would be 100 times 2, or 200. Analogously, if a message is constrained by loop undersaturation, and is only displayed every other loop, then the average number of displays per loop is 0.5 m and the resulting count would be 100 times 0.5 or 50.

The invention also provides for a counter to determine the number of times a particular message is actually displayed. Ideally, the actual message counter will be very close to the estimated count, and much of the commercial value of the present invention arises from the ability of this message to accurately and quickly estimate the actual message count. However, because of unforeseen circumstances, such as power outages and the like, the predicted number of renditions of a message may not always occur and the displayed message counter is generally used to bill for actual renditions of each message.

The invention provides for a report generator for reporting both estimated message renditions and estimated message renditions for a specified reporting time period. A report thus generated can be rendered to a viewing screen, to a persistent medium such as printed copy, or to a transient medium for temporary viewing or storage.

Thus, the present invention provides a system and method to quickly query and report available advertising space in a large digital signage network having a large number of different advertisers and a large number of varied digital advertising venues.

### BRIEF DESCRIPTION OF THE SEVERAL VIEWS OF THE DRAWINGS

FIG. 1 is a block diagram showing generally the basic components of a digital signage system that supports the inventor's unique system of estimating and reporting displayed advertising messages with target display frame detail.

FIG. 2 is a block diagram showing generally the basic components of a digital signage system that supports the inventor's unique system of estimating and reporting displayed advertising messages showing multiple target display frames.

FIG. 3 is a block diagram showing generally the basic components of a digital signage system that supports the inventor's unique system of estimating and reporting displayed advertising messages in the context of an advertising campaign.

### DETAILED DESCRIPTION OF THE INVENTION

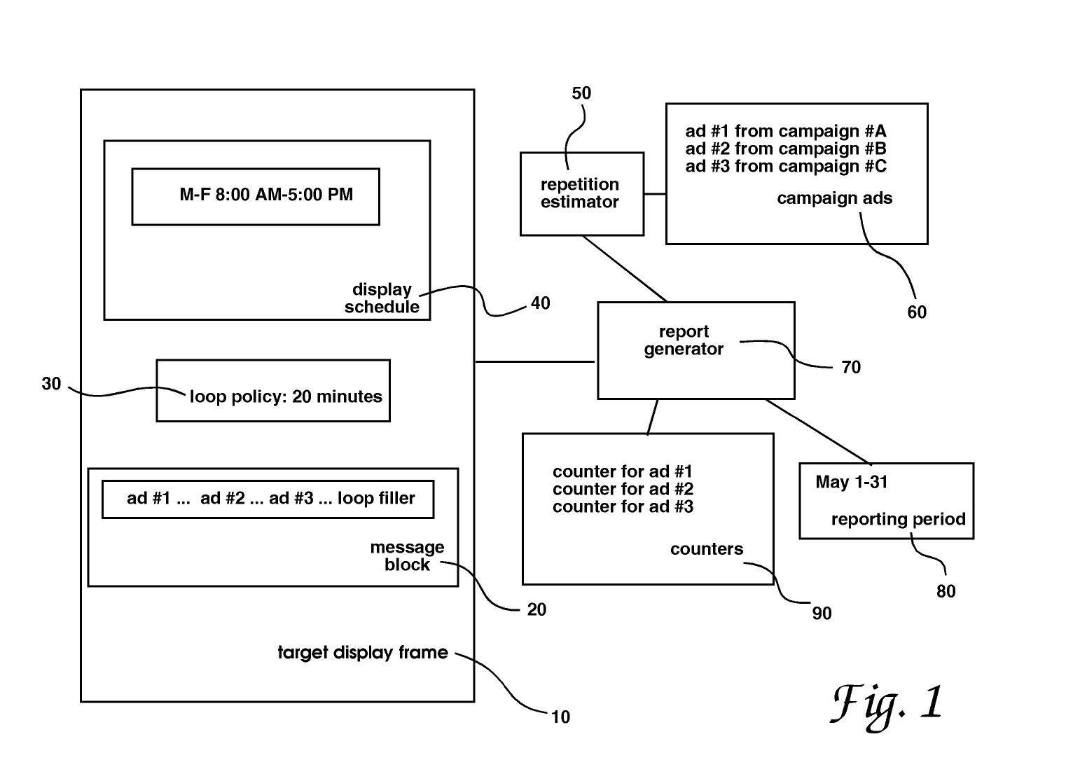

The present invention significantly advances the prior art by providing an efficient way to arrange the components of a network of digital signs to maximize estimation and reporting efficiency. FIG. 1 depicts a block diagram of the basic components of a digital signage system that supports the inventor's unique system of estimating and reporting displayed advertising messages. Referring to FIG. 1, the system depicts at least one target display frame 10. A target display frame 10 denotes the physical screen or portion of a physical screen used to display advertising content along with related structure. A target display frame 10 has an associated display schedule 40 that depicts the appropriate days and times of the target display frame 10. The schedule 40 is generally specified to represent times that the intended target audience will be in viewing range of the screen. For example, if the display frame 10 is located in a retail store, the associated display schedule would likely reflect the operating hours of the store. The display schedule 40 may be a simple schedule as illustrated in FIG. 1, or may be composed of several day-part schedules as described in co-pending patent applications U.S. Provisional Application No. 60/820,591, entitled “Broadcast Day,” and U.S. Provisional Application No. 60/820,595, entitled “Day Part Frame Criteria”.

The target display frame 10 of FIG. 1 also includes a loop policy that specifies with certainty the intended duration of an advertising message block. In FIG. 1, the loop policy specifies duration of 20 minutes. This indicates that content is intended to be repeated every 20 minutes presumably because audience dynamics dictates that the audience will be sufficiently varied every 20 minutes.

The target display frame 10 of FIG. 1 also includes a message block 20. The message block is carefully constructed to include a plurality of successive non-repeating advertising messages. Unused time, if any, is filled with loop filler to ensure that the duration of the message block is very close in time to the required duration specified by the loop policy 30.

FIG. 1 depicts a simplified example with a group of three different campaign ads 60 from three different campaigns A, B and C, for a specified report period 80, which, in the example of FIG. 1 is the month of May. In practice, there are generally a much larger number of ads and campaigns, and a single campaign can specify one or more advertisements (or advertising messages). FIG. 1 also depicts a repetition estimator 50. In the present invention, the repetition estimator can accurately and efficiently predict the number of times a campaign advertising message will actually run using simple linear arithmetic. In the preferred embodiment, for a given campaign ad 60, for a given reporting period 80, the repetition estimator 50 first determines the number of message blocks 20 the campaign ad 60 is scheduled to appear in. The total amount of time the target display frame 10 will be in operation can be calculated by applying the display schedule 40 through the reporting period 80. In the example of FIG. 1, target display frame 10 will be in operation for 13 hours for 31 days for a total of 403 hours for the specified reporting period 80. Applying the loop policy, it is determined each advertisement on target display frame 10 will loop 3 times an hour, so it will be estimated that the specified message in the example of FIG. 1 will be displayed 1209 times during the reporting period. This number may vary from the actual number of repetitions because the display might not be on for some unforeseen reason such as a power outage, but provides a useful and accurate estimate for scheduling purposes.

The system also includes a counter 90 for each advertising method 60, so that messages are counted when they are actually displayed. There are several well known methods for counting displayed messages, including internal counters, wherein the system that delivers the content to the frame increments an appropriate counter. Other system can use external counting systems such as video cameras that actually film an advertisement as it is being displayed to verify the advertisement ran for the benefit of the advertiser.

There are a wide number of variations of estimations and reports of actually displayed messages that may be useful and of interest. For this reason, one embodiment includes a report generator 70 wherein a user can specify one or more time periods of interest, displays of interests, campaigns of interest, advertisers of interest and so forth and generate customized reports based on a variety of input parameters.

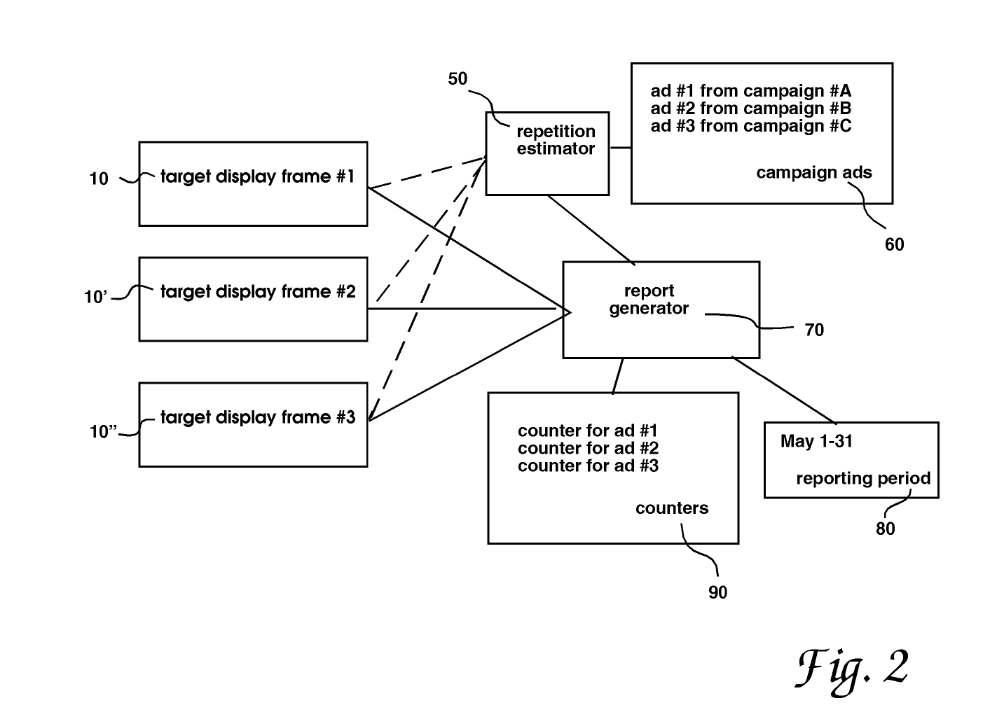

FIG. 1 illustrates a single target frame 10. Typically systems have numerous target display frames within a network which allows advertisers to simultaneously advertise in various venues in the network. FIG. 2 depicts the system of FIG. 1 in a context with multiple target display frames 10. Referring to FIG. 2 which depicts three target display frames 10, 10′ and 10″. The infrastructure of each target display frame 10 is made available to the repetition estimator 50 as shown by the dotted lines. The infrastructure of each target display frame 10 is also available to the report generator 70 so that reports involving multiple target display frames 10 can be designed within the context of the report generator 70.

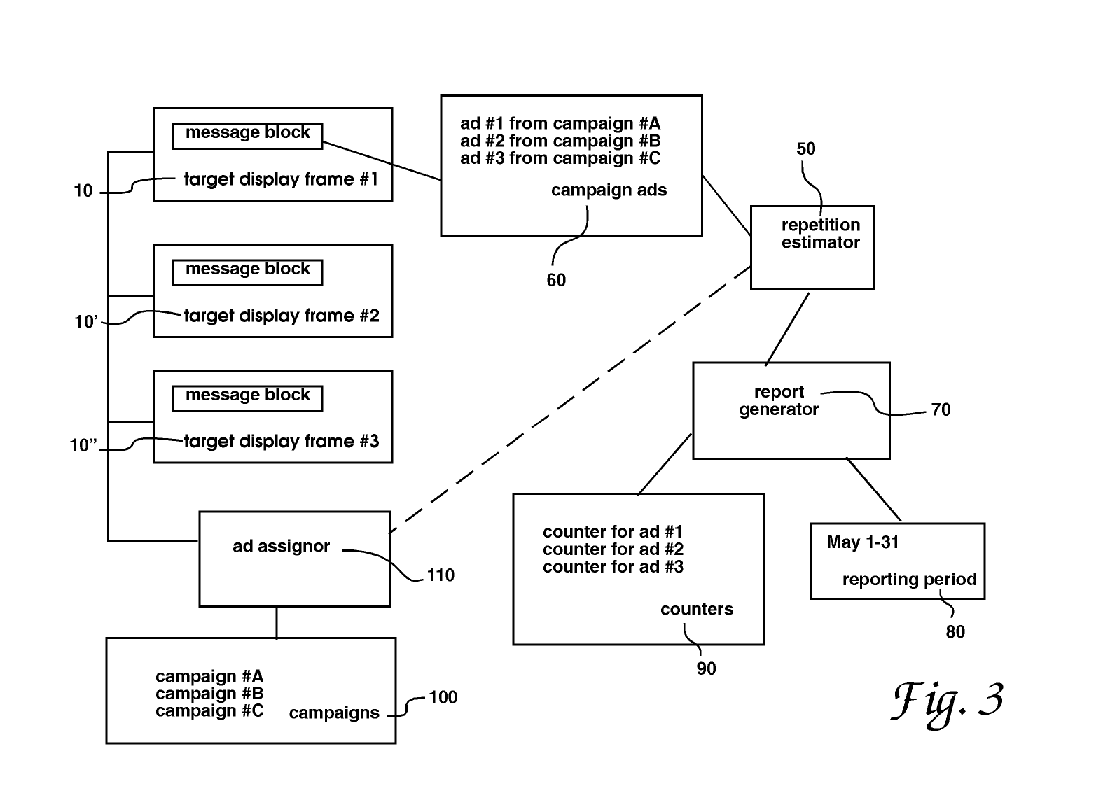

FIG. 3 depicts how the present invention as illustrated in FIG. 1 and FIG. 2 might be utilized by a digital signage system. In a typical digital signage transaction, an advertiser has prepared an advertising campaign including one or more prepared advertisements that the advertiser, for a fee, desires to have displayed on various displays in an advertising network. Typically, the system, either by itself or through interactions with the advertiser or advertising professional, determines available inventory or decides which venues are most appropriate for an advertiser. The campaign advertisements are then assigned various times and locations.

Referring to FIG. 3 which depicts another embodiment, three different advertisement campaigns are displayed from three different advertisers, and are included in a single campaign list 100. Typically, the campaigns are presented to an advertising professional who has access to an ad assignor, a component of the system that can map a prospective advertisement to an available time and place (or slot). Campaigns usually include parameters of how many times a particular ad is supposed to run and type of venue of interest. The ad assignor 110 typically can query the system to appropriate availability. For example, a particular advertiser might want to purchase 10,000 repetitions for a particular advertisement for a particular month. The advertiser may prefer to target grocery stores, if available, but will consider other retail outlets if needed to get the desired exposure. Thus the system can be queried to predict actual renditions that will occur in certain venues. Since the operating hours are encapsulated in the system via the display schedules 40 of FIG. 1, the query generally need not specify time period, instead, in the preferred embodiment, the system can seamless manage issues relating to operating hours. If the target queries produce the desired number of ad placements, then the ad assignor 110 typically will assign the campaign advertisement 60 (of FIG. 2) from each campaign 100 to all of message blocks 20 of all chosen target display frames 10. During the reporting period, the advertisements are run as scheduled, and billing, adjustments, based on the counters 90, can be made if necessary.

A key and innovative feature is the ability to rapidly predict the number of available slots in a large system. The linear arithmetic nature of the computations makes its estimation occur rapidly. The rapid estimation is only possible, however, if the system, as exemplified by the present invention. In particular, schedules associated with display frames, loop policies with fixed durations, message blocks of predetermined and fixed length, all combine to allow extremely fast and accurate estimations and reporting.

This description is provided for the purposes of illustration, not limitation. As one skilled in the art will appreciate, there are a number of alternate embodiments of the present invention not shown, that are in the spirit of the invention. The invention is only limited by the claims as set forth below.

We claim:

1. A system for advertising in a digital signage environment comprising:
a plurality of campaign advertising messages,
a plurality of target display frames, each target display frame further includes:
a display schedule that identifies appropriate days and times to display advertising messages on the corresponding target display frame,
a loop policy, the loop policy identifies a looping time period for the corresponding target display frame,
an advertising message block, the advertising message block is formed by concatenating each campaign advertising message, and further concatenating a loop filler, to form a stream of a duration approximately equal to the looping time period,
wherein each campaign advertising message occurs exactly once in said advertising message block,
wherein said advertising message block is repeatedly played on said target display frame in a looping fashion for all appropriate days and times identified by the display schedule.

2. The system of claim 1 further comprising:
a reporting period,
for each campaign advertising message, a repetition estimator, the repetition estimator produces an estimate of the predicted number of times said campaign advertising message will display in on said target display frame during said specified reporting period,
for each campaign advertising message, a displayed message counter wherein each display message counter counts the number of times an advertising message is actually displayed on said target display frame during said reporting period,
a report generator, wherein a report is generated including, for at least one campaign advertising message that includes said estimate produced by said repetition estimator, and further includes the value of the associated display message counter.
a report renderer, wherein a report is rendered showing the number of estimated repetitions and the number of actual repetitions for at least one advertising slot of said specified reporting period.

3. The system of claim 2,
wherein said generated report is rendered to a viewing screen.

4. The system of claim 3,
wherein said generated report is rendered to a persistent medium.

5. The system of claim 4,
wherein said generated report is rendered to a transient medium.

6. The system of claim 5,
wherein said repetition estimator calculates said number of estimated repetitions by forming estimation result E1 by calculating T1 by consulting said display schedules and determining the total amount of time appropriate for display messages during the reporting period on the target display frame, then dividing T1 by the loop time specified in the loop policy.

7. The system of claim 6,
wherein, in the case of loop saturation, said repetition estimator calculates, for each campaign advertising message M1, A1 wherein A1 is the average number of time M1 is displayed each loop cycle, and then forms an estimation result E2 by multiplying E1 by A1.

8. A method for advertising in a digital signage environment comprising the steps of:
associating a plurality of campaign advertising messages with digital signage environment,
associating a plurality of target display frames with digital signage environment, each target display frame further includes:
a display schedule that identifies appropriate days and times to display advertising messages on the corresponding target display frame,
a loop policy, the loop policy identifies a looping time period for the corresponding target display frame,
an advertising message block, the advertising message block is formed by concatenating each campaign advertising message, and further concatenating a loop filler, to form a stream of a duration approximately equal to the looping time period,
wherein each campaign advertising message occurs exactly once in said advertising message block,
wherein said advertising message block is repeatedly played on said target display frame in a looping fashion for all appropriate days and times identified by the display schedule.

9. The method of claim 8 further comprising the steps of:
associating a reporting period with digital signage environment,
associating for each campaign advertising message, a repetition estimator with digital signage environment, the repetition estimator produces an estimate of the predicted number of times said campaign advertising message will display in on said target display frame during said specified reporting period,
associating for each campaign advertising message, a displayed message counter wherein each display message counter counts the number of times an advertising message is actually displayed on said target display frame during said reporting period with digital signage environment,
associating a report generator with digital signage environment, wherein a report is generated including, for at least one campaign advertising message that includes said estimate produced by said repetition estimator, and further includes the value of the associated display message counter.
associating a report renderer with digital signage environment, wherein a report is rendered showing the number of estimated repetitions and the number of actual repetitions for at least one advertising slot of said specified reporting period.

10. The method of claim 9,
wherein said generated report is rendered to a viewing screen.

11. The method of claim 10,
wherein said generated report is rendered to a persistent medium.

12. The method of claim 11,
wherein said generated report is rendered to a transient medium.

13. The method of claim 12,
wherein said repetition estimator calculates said number of estimated repetitions by forming estimation result E1 by calculating T1 by consulting said display schedules and determining the total amount of time appropriate for display messages during the reporting period on the target display frame, then dividing T1 by the loop time specified in the loop policy.

14. The method of claim 13,
wherein, in the case of loop saturation, said repetition estimator calculates, for each campaign advertising message M1, A1 wherein A1 is the average number of time M1 is displayed each loop cycle, and then forms an estimation result E2 by multiplying E1 by A1.
